(19) United States
(12) Patent Application Publication
(10) Pub. No.: US 2025/0048947 A1
(43) Pub. Date: Feb. 13, 2025

(54) AGRICULTURAL IMPLEMENT WITH LEVELING DISK GANGS

(71) Applicant: CNH Industrial America LLC, New Holland, PA (US)

(72) Inventors: Brittany Schroeder, Bunker Hill, IN (US); Joshua D. Knoblauch, Lowpoint, IL (US)

(21) Appl. No.: 18/447,616

(22) Filed: Aug. 10, 2023

(51) Int. Cl. A01B 35/18; A01B 35/28; A01B 49/02

(52) U.S. Cl. CPC A01B 35/18; A01B 35/28; A01B 49/027

(57) ABSTRACT

An agricultural implement includes a frame extending between a forward end, an aft end, a first side, and a second side. Additionally, the implement includes shanks configured to engage the soil. Furthermore, the implement includes a first leveling disk gang positioned aft of the shanks including a first plurality of disk blades configured to rotate relative to the soil. Moreover, the implement includes a second leveling disk gang positioned aft of the first disk gang including a second plurality of disk blades configured to rotate relative to the soil. Additionally, each disk blade of the first plurality of disk blades and the second plurality of disk blades is configured to turn the soil over such that the soil moves away from the first plurality of disk blades and the second plurality of disk blades, respectively, and toward the first side or the second side of the implement.

### FIELD OF THE INVENTION

The present disclosure generally relates to agricultural implements and, more particularly, to an agricultural implement with leveling disk gangs.

### BACKGROUND OF THE INVENTION

It is well known that, to attain the best agricultural performance from a field, a farmer must cultivate the soil, typically through a tillage operation. Modern farmers perform tillage operations by pulling an agricultural implement, such as a tillage implement, behind an agricultural work vehicle, such as a tractor. For example, tillage implements generally include ground-engaging tillage tools, such as shanks, disk blades, and/or the like, supported on its frame. Each ground-engaging tool, in turn, is configured to be moved relative to the soil within the field as the tillage implement travels across the field. Such movement of the ground-engaging tools loosens and/or otherwise agitates the soil to prepare the field for subsequent planting operations.

As the tillage implement travels across the field, the implement may encounter varying field conditions. For example, the implement may encounter rocks, soil clods, and/or other impediments that may require additional tilling to achieve a desired soil surface finish.

Accordingly, an improved agricultural implement with leveling disk gangs would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural implement. The agricultural implement includes a frame extending between a forward end and an aft end along a longitudinal direction that is parallel to a direction of travel of the agricultural implement. The frame also extends between a first side and a second side in a lateral direction extending perpendicular to the longitudinal direction. Moreover, the agricultural implement includes a plurality of ground-engaging shanks mounted to the frame and configured to engage the soil of a field as the agricultural implement travels across the field. Additionally, the agricultural implement includes a first leveling disk gang assembly mounted to the frame and positioned aft of the plurality of ground-engaging shanks relative to the direction of travel. Furthermore, the first leveling disk gang assembly includes a first plurality of disk blades configured to rotate relative to the soil of the field. Moreover, the agricultural implement includes a second leveling disk gang assembly mounted to the frame and positioned aft of the first leveling disk gang assembly relative to the direction of travel. Additionally, the second leveling disk gang assembly includes a second plurality of disk blades configured to rotate relative to the soil of the field. Furthermore, each disk blade of the first plurality of disk blades is configured to turn the soil over such that the soil moves aft of the first plurality of disk blades and toward at least one of the first side or the second side of the agricultural implement. Moreover, each disk blade of the second plurality of disk blades is configured to turn the soil over such that the soil moves aft of the second plurality of disk blades in and toward at least one of the first side of the second side of the agricultural implement.

In another aspect, the present subject matter is directed to a tillage implement. The tillage implement includes a frame extending between a forward end and an aft end along a longitudinal direction that is parallel to a direction of travel of the tillage implement. The frame also extends between a first side and a second side in a lateral direction extending perpendicular to the longitudinal direction. Moreover, the tillage implement includes a plurality of harrow disks mounted to the frame and configured to engage the soil of a field as the agricultural implement travels across the field. Additionally, the tillage implement includes a plurality of shank assemblies mounted to the frame and configured to engage the soil of the field as the agricultural implement travels across the field, the plurality of shank assemblies positioned aft of the plurality of harrow disks relative to the direction of travel. Furthermore, the tillage implement includes a first leveling disk gang assembly mounted to the frame and positioned aft of the plurality of shank assemblies relative to the direction of travel. Moreover, the first leveling disk gang assembly includes a first plurality of disk blades configured to rotate relative to the soil of the field. Additionally, the tillage implement includes a second leveling disk gang assembly mounted to the frame and positioned aft of the first leveling disk gang assembly relative to the direction of travel. Furthermore, the second leveling disk gang assembly includes a second plurality of disk blades configured to rotate relative to the soil of the field. Moreover, each disk blade of the first plurality of disk blades is configured to turn the soil over such that the soil moves aft of the first plurality of disk blades and toward at least one of the first side or the second side of the tillage implement. Additionally, each disk blade of the second plurality of disk blades is configured to turn the soil over such that the soil moves aft of the second plurality of disk blades in and toward at least one of the first side or the second side of the tillage implement.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a top view of one embodiment of an agricultural implement in accordance with aspects of the present subject matter;

FIG. 2 illustrates a front view of one embodiment of a leveling disk gang assembly of an agricultural implement, particularly illustrating concave sides of each disk blade facing a first side of the agricultural implement, in accordance with aspects of the present subject matter; and

FIG. 3 illustrates a front view of one embodiment of a leveling disk gang assembly of an agricultural implement, particularly illustrating concave sides of each disk blade facing a second side of the agricultural implement, in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to an agricultural implement, such as a tillage implement. As will be described below, the agricultural implement includes a plurality of ground-engaging shanks and may include a plurality of harrow disks mounted to a frame of the implement forward of the ground-engaging shanks and configured to engage the soil of the field.

Additionally, the implement includes two or more leveling disk gang assemblies mounted to the frame aft of the ground-engaging shanks. Specifically, in several embodiments, the implement may include a first leveling disk gang and a second leveling disk gang mounted aft of the first leveling disk gang. The first leveling disk gang includes a first plurality of disk blades configured to rotate relative to the soil of the field. Likewise, the second leveling disk gang includes a second plurality of disk blades configured to rotate relative to the soil of the field. The first plurality of disk blades is configured to turn the soil over such that the soil moves aft of the first plurality of disk blades and toward at least one of a first side or a second side of the implement. Likewise, the second plurality of disk blades is configured to turn the soil over such that the soil moves aft of the second plurality of disk blades and toward at least one of the first side or the second side of the implement. A concave side defined by each disk blade of the first plurality of disk blades faces the opposite side of the implement than the concave side defined by each disk blade of the second plurality of disk blades such that the second plurality of disk blades turns the soil over in an opposite direction than the first plurality of disk blades.

Leveling disk gangs positioned in successive rows on the implement and with opposite facing concave sides improves the surface finish of the field. As the tillage implement travels across the field, the implement may encounter varying field conditions. For example, the implement may encounter rocks, soil clods, and/or other impediments that may require additional tilling to achieve a desired soil surface finish not achievable with current implement configurations. As such, opposite facing concave sides of the disk blades between the forward and aft rows of disk blades improves the surface finish of the field, such as by turning over the soil and/or closing the furrows created by the ground-engaging shanks of the implement. Additionally, gang mounted disk blades may be better suited to break up soil clods missed by other ground-engaging tools of the implement.

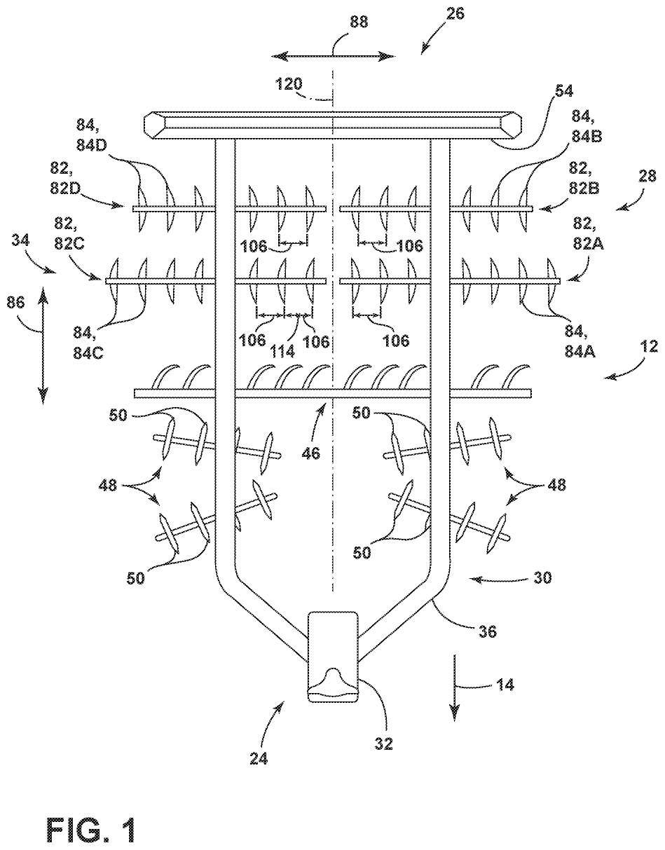

Referring now to drawings, FIG. 1 illustrates a top view of one embodiment of an agricultural implement 12 in accordance with aspects of the present subject matter. In this respect, the implement 12 is configured to be towed across a field in a travel direction (e.g., as indicated by arrow 14) by a suitable work vehicle (not shown), such as an agricultural tractor.

As shown, in the illustrated embodiment, the agricultural implement 12 is configured as a tillage implement (e.g., a disk ripper). However, in alternative embodiments, the agricultural implement 12 may be configured as any other suitable type of agricultural implement.

As shown in FIG. 1, the implement 12 may generally include a frame 30 configured to be towed by the work vehicle (not shown) via a pull hitch or tow bar 32 in the travel direction 14 of the implement 12. The frame 30 extends between a forward end 24 and an aft end 26 along a longitudinal direction 86 parallel to the direction of travel 14. The frame 30 also extends between a first side 28 and a second side 34 in a lateral direction 88 perpendicular to the longitudinal direction 86. Furthermore, the frame 30 may have any suitable combination of bars, beams, and/or other structural members.

Furthermore, as shown in FIG. 1, the frame 30 supports a plurality of ground-engaging tools. In several embodiments, the various ground-engaging tools may be configured to perform an agricultural operation, such as a tillage operation, across the field along which the implement 12 is being towed. For example, in one embodiment, the frame 30 may be configured to support various harrow gangs or sets 48 of harrow blades 50. Specifically, the harrow blades 50 are spaced apart from each other along the length of the corresponding harrow gang 48 and configured to engage or rotate relative to the soil within the field as the implement 12 travels across the field in the travel direction 14. In addition, the various harrow gangs 48 of harrow blades 50 may be oriented at an angle relative to the travel direction 14 of the implement 12 to promote more effective tilling of the soil.

Additionally, as shown in FIG. 1, the frame 30 supports a plurality of ground-engaging shanks 46. In such an embodiment, the shanks 46 are configured to till or otherwise engage the soil as the implement 12 is towed across the field. Additionally, the plurality of ground-engaging shanks 46 may be supported by the frame 30 aft of the harrow gangs 48 relative to the direction of travel 14.

Moreover, as shown in FIG. 1, the frame 30 supports at least two leveling disk gang assemblies 82 positioned aft of the plurality of ground-engaging shanks 46. Each leveling disk gang assembly 82 includes a plurality of leveling disk blades 84. For example, as shown in FIG. 1, the frame 30 supports a first, second, third, and fourth leveling disk gang assembly 82A, 82B, 82C, 82D supported aft of the plurality of ground-engaging shanks 46. Each leveling disk gang assembly 82A, 82B, 82C. 82D includes a first, second, third, and fourth plurality of leveling disk blades 84A, 84B, 84C, 84D, respectively. Moreover, the leveling disk blades 84 are configured to rotate relative to the soil within the field as the implement 12 travels across the field in the travel direction 14. As will be described below, the configuration of the leveling disk gangs 82 is configured to improve the surface finish of the field, such as by turning over the soil.

Additionally, as shown in FIG. 1, the first and second leveling disk gang assemblies 82A, 82B each extend along the lateral direction 88 from the first side 28 of the implement 12 toward an implement centerline 120 parallel to the lateral direction 88 positioned between the first side 28 and the second side 34 of the implement 12. The second leveling disk gang assembly 82B is positioned aft of the first leveling disk gang assembly 82A. Furthermore, the third and fourth leveling disk gang assemblies 82C, 82D extend along the lateral direction 88 from the implement centerline 120 to the second side 34 of the implement 12. The fourth leveling disk gang assembly 82D is positioned aft of the third leveling disk gang assembly 82C.

As shown in FIG. 1, the pluralities of leveling disk blades 84A, 84B, 84C, and 84D are spaced apart along the respective leveling disk gang assembly 82A, 82B, 82C, 82D such that a gap 106 is defined between each spaced apart leveling disk blade 84A, 84B, 84C, 84D. In particular, the gap 106 is defined between each respective pair of leveling disk blades 84A, 84B, 84C, 84D such that each shank 46 is aligned with one of the gaps 106 approximately halfway between the respective pair of leveling disk blades 84A, 84B, 84C, 84D. As such, the configuration of the leveling disk gangs 82A, 82B, 82C, 82D, particularly the spacing of the leveling disk blades 84A, 84B, 84C, 84D improves the surface finish of the field, such as by breaking up soil clods created by the ground-engaging shanks 46 as the implement 12 traverses the field.

Moreover, the frame 30 may be configured to support a plurality of rolling (or crumbler) basket assemblies 54. As shown in FIG. 1, the rolling basket assemblies 54 are supported by the frame 30 aft of the leveling disk gang assemblies 82A, 82B, 82C, 82D.

It should be appreciated that the frame 30 may support any other suitable ground-engaging tools. For example, the frame 30 may support a plurality of tines, spikes, and/or the like.

In addition, the implement 12 may also include any number of suitable ground-engaging tool actuators (e.g., hydraulic cylinders, electric linear actuators, etc.) for adjusting the relative positioning of, the penetration depth of, and/or the force being applied to the various ground-engaging tools 46, 50, 54, 84.

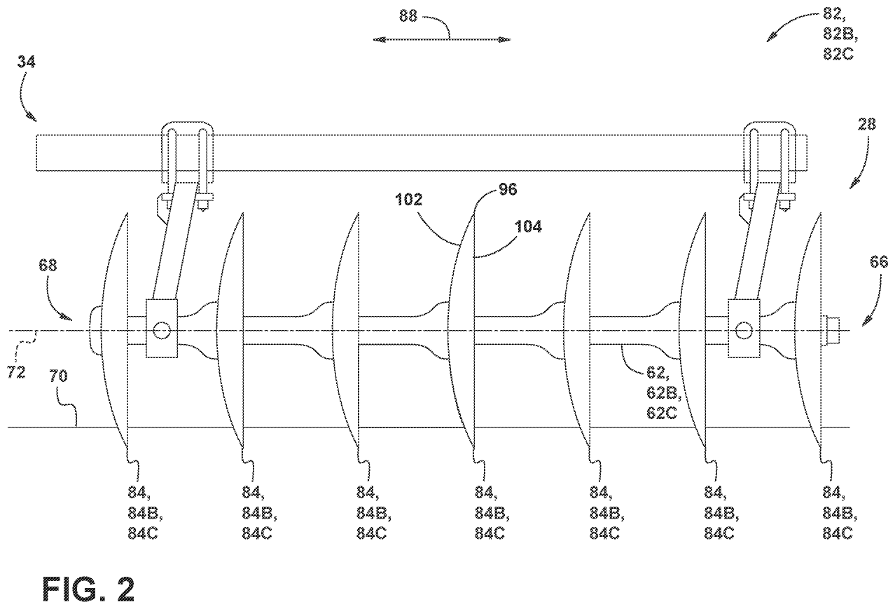

Referring now to FIG. 2, a front view of one embodiment of one of the leveling disk gang assemblies 82 of the implement 12 is illustrated respectively in accordance with aspects of the present subject matter. In particular, FIG. 2 illustrates an embodiment of the leveling disk gang assemblies 82 in which a concave side of each leveling disk blade 84 facing a first side of the implement 12 (e.g., the leveling disk gang assemblies 82B and 82C shown in FIG. 1).

In several embodiments, each leveling disk gang assembly 82 may include a leveling disk gang shaft 62 that extends between a first end 66 and a second end 68 along the lateral direction 88. For example, the second leveling disk gang assembly 82B and the third leveling disk gang assembly 82C may include a second shaft 62B and a third shaft 62C, respectively. The second shaft 62B and the third shaft 62C, in turn, extend along the lateral direction 88 such that the leveling disk blades 84B, 84C are oriented parallel to the direction of travel 14 (FIG. 1). Additionally, the second plurality of leveling disk blades 84B and the third plurality of leveling disk blades 84C are coupled to the respective leveling disk gang shaft 62B, 62C and spaced apart from each other along the lateral direction 88. In this respect, as the implement 12 travels across a field, the leveling disk blades 84B, 84C penetrate the soil surface (e.g., as indicated by line 70) of the field and rotate about an axis of rotation (e.g., as indicated by dashed line 72) relative to the soil within the field. As such, a flow zone 36 is defined between each pair of leveling disk blades 84B, 84C.

Moreover, as shown in FIG. 2, the leveling disk blades 84B, 84C each include a convex side 102 and a concave side 104 opposite the convex side 102. The leveling disk blades 84B, 84C are rotatably coupled to the corresponding leveling disk gang shafts 62B, 62C such that the concave side 104 of each leveling disk blade 84B. 84C faces the first side 28 of the implement 12 and the convex side 102 of each leveling disk blade 84B, 84C faces the second side 34 of the implement 12. Additionally, each leveling disk blade 84B, 84C includes an edge 96 separating the convex side 102 and the concave side 104 for engaging the soil of a field surface as the leveling disk blades 84B, 84C rotate about the axis of rotation 72. As such, as each of the leveling disk blades 82B rotate about the axis of rotation 72 as the implement 12 traverses the field, soil may be turned over by the concave portion 104 such that the soil moves aft of the second plurality of leveling disk blades 84B and toward the first side 28 of the implement 12. Likewise, as each of the leveling disk blades 82C rotate about the axis of rotation 82 as the implement 12 traverses the field, soil may be turned over by the concave portion 104 such that the soil moves aft of the third plurality of leveling disk blades 84C and toward the first side 28 of the implement 12.

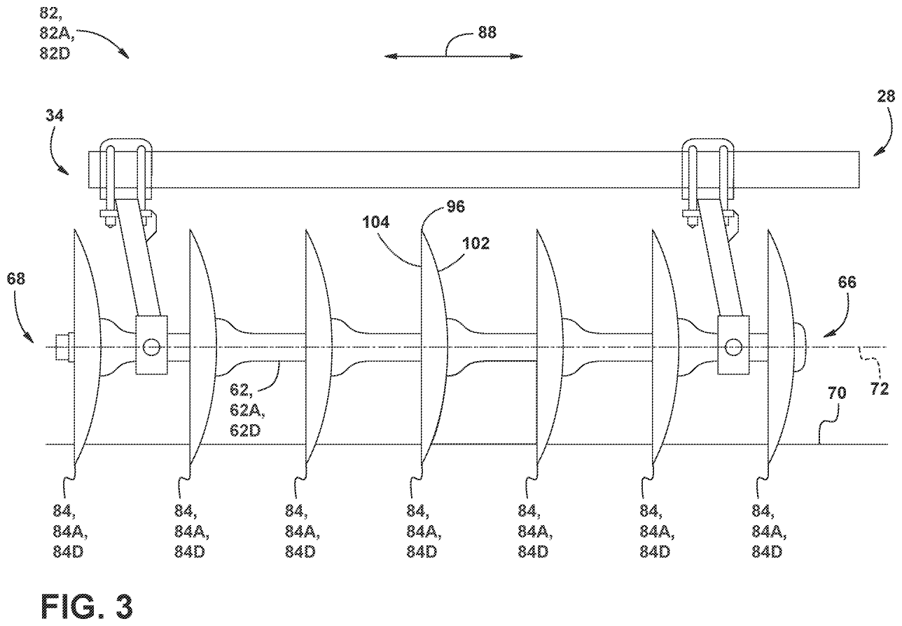

Referring now to FIG. 3, a front view of one embodiment of one of the leveling disk gang assemblies 82 of the implement 12 is illustrated respectively in accordance with aspects of the present subject matter. In particular, FIG. 3 illustrates an embodiment of the leveling disk gang assemblies 82 in which a concave side of each leveling disk blade 84 faces a second side of the implement 12 (e.g., the leveling disk gang assemblies 82A and 82D shown in FIG. 1). In several embodiments, the first leveling disk gang assembly 82A and the fourth leveling disk gang assembly 82D may include a first shaft 62A and a fourth shaft 62D, respectively. The first shaft 62A and the fourth shaft 62D, in turn, extend along the lateral direction 88 such that the leveling disk blades 84A, 84D are oriented parallel to the direction of travel 14 (FIG. 1). Additionally, the first plurality of leveling disk blades 84A and the fourth plurality of leveling disk blades 84D are coupled to the respective leveling disk gang shaft 62A, 62D and spaced apart from each other along the lateral direction 88. In this respect, as the implement 12 travels across a field, the leveling disk blades 84A, 84D penetrate the soil surface (e.g., as indicated by line 70) of the field and rotate about the axis of rotation (e.g., as indicated by dashed line 72) relative to the soil within the field. As such, the flow zone 36 is defined between each pair of leveling disk blades 84A, 84D.

Moreover, as shown in FIG. 3, the leveling disk blades 84A, 84D each include the convex side 102 and the concave side 104 opposite the convex side 102. The leveling disk blades 84A, 84D are rotatably coupled to the leveling disk gang shafts 62A, 62D, respectively, such that the concave side 104 of each leveling disk blade 84A, 84D faces the second side 34 of the implement 12 and the convex side 102 of each leveling disk blade 84A, 84D faces the first side 28 of the implement 12. Additionally, each leveling disk blade 84A, 84D includes the edge 96 separating the convex side 102 and the concave side 104 for engaging the soil of a field surface as the leveling disk blades 84A, 84D rotate about the axis of rotation 72. As such, as each of the leveling disk blades 82A rotate about the axis of rotation 72 as the implement 12 traverses the field, soil may be turned over by the concave portion 104 such that the soil moves aft of the first plurality of leveling disk blades 84A and toward the second side 34 of the implement 12. Likewise, as each of the leveling disk blades 82D rotate about the axis of rotation 82 as the implement 12 traverses the field, soil may be turned over by the concave portion 104 such that the soil moves aft of the fourth plurality of leveling disk blades 84D and toward the second side 34 of the implement 12.

Opposite facing concave sides 104 between the second/third plurality of leveling disk blades 84B, 84C and the first/fourth plurality of leveling disk blades 84A, 84D improves the surface finish of the field by turning over the soil in opposite directions. For example, turning over the soil in opposite directions evenly distributes the soil amongst the field. Furthermore, turning over the soil in opposite directions allows the leveling disk blades to further break up soil clods underneath the surface layer.

It should be appreciated that the concave side 104 of each leveling disk blade of the second and third pluralities of leveling disk blades 84B, 84C may face the second side 34 of the implement 12 while the concave side 104 of each leveling disk blade of the first and fourth pluralities of leveling disk blades 84A, 84D may face the first side 28 of the implement 12.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural implement, comprising:
a frame extending between a forward end and an aft end along a longitudinal direction that is parallel to a direction of travel of the agricultural implement, the frame further extending between a first side and a second side in a lateral direction extending perpendicular to the longitudinal direction;
a plurality of ground-engaging shanks mounted to the frame and configured to engage the soil of a field as the agricultural implement travels across the field;
a first leveling disk gang assembly mounted to the frame and positioned aft of the plurality of ground-engaging shanks relative to the direction of travel, the first leveling disk gang assembly including a first plurality of disk blades configured to rotate relative to the soil of the field; and
a second leveling disk gang assembly mounted to the frame and positioned aft of the first leveling disk gang assembly relative to the direction of travel, the second leveling disk gang assembly including a second plurality of disk blades configured to rotate relative to the soil of the field,
wherein each disk blade of the first plurality of disk blades is further configured to turn the soil over such that the soil moves aft of the first plurality of disk blades and toward at least one of the first side or the second side of the agricultural implement, and
wherein each disk blade of the second plurality of disk blades is further configured to turn the soil over such that the soil moves aft of the second plurality of disk blades and toward at least one of the first side of the second side of the agricultural implement.

2. The agricultural implement of claim 1, wherein:
each disk blade of the first plurality of disk blades defines a concave side and a convex side and is oriented such that the concave side faces the second side of the agricultural implement and the convex side faces the first side of the agricultural implement; and
each disk blade of the second plurality of disk blades defines a concave side and a convex side and is oriented such that the convex side faces the second side of the agricultural implement and the concave side faces the first side of the agricultural implement.

3. The agricultural implement of claim 1, wherein:
each disk blade of the first plurality of disk blades defines a concave side and a convex side and is oriented such that the convex side faces the second side of the agricultural implement and the concave side faces the first side of the agricultural implement; and
each disk blade of the second plurality of disk blades defines a concave side and a convex side and is oriented such that the concave side faces the second side of the agricultural implement and the convex side faces the first side of the agricultural implement.

4. The agricultural implement of claim 1, wherein:
the first leveling disk gang assembly includes a first shaft extending between a first end and a second end, each disk blade of the first plurality of disk blades rotatably coupled to the first shaft and spaced apart along the first shaft between the first and second ends; and
the second leveling disk gang assembly includes a second shaft extending between a first end and a second end, each disk blade of the second plurality of disk blades rotatably coupled to the second shaft and spaced apart along the second shaft between the first and second ends.

5. The agricultural implement of claim 4, wherein:
the first shaft extends between the first and second ends along the lateral direction; and
the second shaft extends between the first and second ends along the lateral direction.

6. The agricultural implement of claim 1, further comprising:
an actuator configured to apply a force to at least one of the first leveling disk gang assembly or the second leveling disk gang assembly.

7. The agricultural implement of claim 1, further comprising:
a third leveling disk gang assembly mounted to the frame and positioned between the second side of the agricultural implement and the first leveling disk gang assembly and aft of the plurality of ground-engaging shanks relative to the direction of travel, the third leveling disk gang assembly including a third plurality of disk blades configured to rotate relative to the soil of the field; and
a fourth leveling disk gang assembly mounted to the frame and positioned between the second side of the agricultural implement and the second leveling disk gang assembly and aft of the third leveling disk gang assembly relative to the direction of travel, the fourth leveling disk gang assembly including a fourth plurality of disk blades configured to rotate relative to the soil of the field.

8. The agricultural implement of claim 7, wherein:
each disk blade of the third plurality of disk blades defines a concave side and a convex side and is oriented such that the convex side faces the second side of the agricultural implement and the concave side faces the first side of the agricultural implement; and
each disk blade of the fourth plurality of disk blades defines a concave side and a convex side and is oriented such that the concave side faces the second side of the agricultural implement and the convex side faces the first side of the agricultural implement.

9. The agricultural implement of claim 7, wherein:
each disk blade of the third plurality of disk blades defines a concave side and a convex side and is oriented such that the convex side faces the second side of the agricultural implement and the concave side faces the first side of the agricultural implement; and
each disk blade of the fourth plurality of disk blades defines a concave side and a convex side, each disk blade of the fourth plurality of disk blades oriented such that the concave side faces the second side of the agricultural implement and the convex side faces the first side of the agricultural implement.

10. A tillage implement, comprising:
a frame extending between a forward end and an aft end along a longitudinal direction that is parallel to a direction of travel of the tillage implement, the frame further extending between a first side and a second side in a lateral direction extending perpendicular to the longitudinal direction;
a plurality of harrow disks mounted to the frame and configured to engage the soil of a field as the tillage implement travels across the field;
a plurality of shank assemblies mounted to the frame and configured to engage the soil of the field as the tillage implement travels across the field, the plurality of shank assemblies positioned aft of the plurality of harrow disks relative to the direction of travel;
a first leveling disk gang assembly mounted to the frame and positioned aft of the plurality of shank assemblies relative to the direction of travel, the first leveling disk gang assembly including a first plurality of disk blades configured to rotate relative to the soil of the field; and
a second leveling disk gang assembly mounted to the frame and positioned aft of the first leveling disk gang assembly relative to the direction of travel, the second leveling disk gang assembly including a second plurality of disk blades configured to rotate relative to the soil of the field,
wherein, each disk blade of the first plurality of disk blades is configured to turn the soil over such that the soil moves aft of the first plurality of disk blades and toward at least one of the first side or the second side of the tillage implement; and
wherein, each disk blade of the second plurality of disk blades is configured to turn the soil over such that the soil moves aft of the second plurality of disk blades and toward at least one of the first side of the second side of the tillage implement.

11. The tillage implement of claim 10, wherein:
each disk blade of the first plurality of disk blades defines a concave side and a convex side and is oriented such that the concave side faces the second side of the tillage implement and the convex side faces the first side of the tillage implement; and
each disk blade of the second plurality of disk blades defines a concave side and a convex side and is oriented such that the convex side faces the second side of the tillage implement and the concave side faces the first side of the tillage implement.

12. The tillage implement of claim 10, wherein:
each disk blade of the first plurality of disk blades defines a concave side and a convex side and is oriented such that the convex side faces the second side of the tillage implement and the concave side faces the first side of the tillage implement; and
each disk blade of the second plurality of disk blades defines a concave side and a convex side and is oriented such that the concave side faces the second side of the tillage implement and the convex side faces the first side of the tillage implement.

13. The tillage implement of claim 10, wherein:
the first leveling disk gang assembly includes a first shaft extending between a first end and a second end, each disk blade of the first plurality of disk blades rotatably coupled to the first shaft and spaced apart along the first shaft between the first and second ends; and
the second leveling disk gang assembly includes a second shaft extending between a first end and a second end, each disk blade of the second plurality of disk blades rotatably coupled to the second shaft and spaced apart along the second shaft between the first and second ends.

14. The tillage implement of claim 13, wherein:
the first shaft extends between the first and second ends along the lateral direction; and
the second shaft extends between the first and second ends along the lateral direction.

15. The tillage implement of claim 10, further comprising:
an actuator configured to apply a force to at least one of the first leveling disk gang assembly or the second leveling disk gang assembly.

16. The tillage implement of claim 10, further comprising:
a third leveling disk gang assembly mounted to the frame and positioned between the second side of the tillage implement and the first leveling disk gang assembly and aft of the plurality of shank assemblies relative to the direction of travel, the third leveling disk gang assembly including a third plurality of disk blades configured to rotate relative to the soil of the field; and
a fourth leveling disk gang assembly mounted to the frame and positioned between the second side of the tillage implement and the second leveling disk gang assembly and aft of the third leveling disk gang assembly relative to the direction of travel, the fourth leveling disk gang assembly including a fourth plurality of disk blades configured to rotate relative to the soil of the field.

17. The tillage implement of claim 16, wherein:
each disk blade of the third plurality of disk blades defines a concave side and a convex side and is oriented such that the convex side faces the second side of the tillage implement and the concave side faces the first side of the tillage implement; and
each disk blade of the fourth plurality of disk blades defines a concave side and a convex side and is oriented such that the concave side faces the second side of the tillage implement and the convex side faces the first side of the tillage implement.

18. The tillage implement of claim 16, wherein:
each disk blade of the third plurality of disk blades defines a concave side and a convex side and is oriented such that the convex side faces the second side of the tillage implement and the concave side faces the first side of the tillage implement; and
each disk blade of the fourth plurality of disk blades defines a concave side and a convex side and is oriented such that the concave side faces the second side of the tillage implement and the convex side faces the first side of the tillage implement.
